(19) United States
(12) Patent Application Publication
(10) Pub. No.: US 2019/0263991 A1
(43) Pub. Date: Aug. 29, 2019

(54) Improved Expandable Vinyl Aromatic Polymers

(71) Applicant: Total Research & Technology Feluy, Seneffe (BE)

(72) Inventors: Jacques Michel, Feluy (BE); Jean-Claude Deleye, Herne (BE); Laetitia Urbanczyk, La Louviére (BE); Magali Vachaudez, Neufmaison (BE); Amelio Iacolina, Sirault (BE); Michel Cassart, Braine l'Alleud (BE)

(21) Appl. No.: 16/340,731

(22) PCT Filed: Oct. 6, 2017
(86) PCT No.: PCT/EP2017/075509

§ 371 Date: Apr. 10, 2019

(30) Foreign Application Priority Data
Oct. 10, 2016 (EP) 16193081.3

(51) Int. Cl. C08J 9/00; C08J 9/16; C08J 9/14; C08J 9/228

(52) U.S. Cl. CPC C08J 9/0061; C08J 9/0066; C08J 9/16; C08J 9/141; C08J 2203/14; C08J 2325/06; C08J 2453/02; C08J 2423/06; C08J 9/228

(57) ABSTRACT

The present invention is related to expandable vinyl aromatic polymers comprising from 1 to 10% by weight of homogeneously dispersed coke particles having a volume median particle diameter (D50) comprised between 0.5 and 8.5 μm and from 0.1 to 5% by weight of a halogenated block copolymer. The invention further is related to a method for producing said expandable vinyl aromatic polymers and to the expanded foams.

### FIELD OF THE INVENTION

The present invention relates to particulate expandable vinyl aromatic polymers containing coke particles, their production and foams produced therefrom.

### STATE OF THE ART

Expanded vinyl aromatic foams, in particular polystyrene foams have been known for a long time and have numerous applications in many fields. Such foams are produced by heating polystyrene particles impregnated with blowing agents in a prefoamer to achieve an expansion in one or two steps. The expanded particles are then conveyed in a mold where they are sintered to achieve molded parts. In the case of thermal insulation panels, the molded parts are blocks of about 1 m thickness which are later cut into the requested panel thickness. Besides thermal insulation, properties like flame resistance and compression resistance are of key importance while lower foam densities continue to be a target.

Without any athermanous additives (defined as “absorbing or reflecting radiant heat in certain wave-length regions of the infra-red spectrum”) panels of expanded polystyrene foams have a minimum thermal conductivity at densities around 30 kg/m³ and only values of more than about 34 mW/mK can be achieved. To save material and to increase the insulation performance, it is nevertheless desirable to use foam boards having lower densities, in particular 15 kg/m³ or even less. The production of such foams is not a problem in technical terms. However, without athermanous particles, such foam boards have a drastically worse thermal insulation performance so that they do not meet the requirements of the requested thermal conductivity classes. The thermal conductivity usually exceeds 36 mW/m·K; typically a thermal conductivity of 38 and 36 mW/m·K can be achieved with a foam density of around 14 and 18 kg/m³, respectively.

Since the early patents U.S. Pat. No. 4,795,763 (1989), WO 90/06339 and EP 0372343 (1989), it is known that the thermal conductivity of foams can be reduced by incorporation of athermanous materials such as carbon black.

The incorporation of thermal insulation increasing material in expandable vinyl aromatic polymers is disclosed in for example EP 1486530, EP 620246, EP 0915127, EP 1945700, EP 1877473, EP 372343, EP 902804, EP 0863175, EP 1137701, EP 1102807, EP 0981575, EP 2513209, EP 0915127, DE 19910257, WO 9851735, WO 2004/087798, WO 2011/042800, WO 2011/133035, WO 2011/122034, WO 2014/102139, WO 97/45477, EP 0674674, WO 2004/087798, WO 2008/061678, WO 2011/042800 and JP 2005002268.

Incorporation of coke as athermanous filler is for example disclosed in EP 2274370, EP 2358798, EP 2454313, US 2011/213045, DE 202010013850, WO 2010/128369, WO 2010/141400, WO 2011/110333, WO 2013/064444, WO 2014/063993, WO 2014/102137 and WO 2014/122190.

In order to get fire resistance, flame retardant agents, usually halogenated products are added.

The flame-retardant agents particularly suitable to be used in the expandable vinyl aromatic compositions are chlorinated and/or brominated aliphatic, cyclo-aliphatic and aromatic brominated compounds, such as hexabromo-cyclododecane, pentabromomonochlorocyclohexane, tetrabromobisphenol A bis(allyl ether) and pentabromophenyl allyl ether; among the above tetrabromobisphenol A bis(allyl ether) is preferred. Environmental concerns and the regulations involved, enforce a transition towards halogenated polymers.

Halogenated polymers, in particular brominated block copolymers, for use as flame retardant in expandable vinyl aromatic polymers are disclosed in for example WO 2014/111629, WO 2014/027888, WO 2013/009469 and WO 2012/044483; yet, their efficiency has never been proven in vinyl aromatic polymer foams comprising dispersed coke particles.

Foam structure is of particular importance in expandable vinyl aromatic polymer foams. Homogeneity and size of the individual cells determine the foaming properties, i.e. expandability and pressure reduction time, and also the foam properties such as mechanical properties, thermal insulation properties and fire resistance. As the number of cells increases, i.e. the cells become finer, the demoulding times (pressure reduction times) decrease drastically. This gives a substantial improvement in the economics of the production process.

For decreasing foam densities, an optimal foam structure becomes extremely important for answering foam properties

Inert particles such as for example talc are known cell regulators in the field of polymer foams.

Typical products considered as nucleating agents are esters of abietic acids, polyoxyethylene sorbitan monolaurate, montan wax, candelilla wax, carnauba wax, paraffine wax, ceresine wax, Japan wax, petrolite wax, ceramer wax, polyethylene wax, polypropylene wax and mixtures thereof.

The use of polyolefin wax and more particularly polyethylene wax as a nucleating agent for the production of vinyl aromatic polymer foams is for example disclosed in U.S. Pat. Nos. 3,224,984; 3,398,105; DE-A-324 38 85; EP 1148088; GB 2110217; U.S. Pat. No. 5,783,612; US 2005/0256245; US 2008/0300328 and WO 2013/081958.

The interaction between athermanous additives and foams is complex. The interaction of the athermanous material with the flame retardant and/or its synergist is a major issue since higher amounts of flame retardant often have to be introduced in the expandable vinyl aromatic polymer so that it can be endowed with fire resistance properties that enable to have a good rating (B1 or B2) according to the DIN 4102-1 test. Moreover all athermanous additives have a certain influence on the cell formation and thus on expansion capabilities, density and open cell rate which again influences fire resistance, thermal conductivity and compression resistance. Most nucleating agents introduced in expandable styrene polymers comprising athermanous additives suffer from one or more limitations and/or drawbacks with regard to uniform cell size and distribution.

Without contesting the associated advantages of the state of the art systems, it is nevertheless obvious that there is still a need for expandable vinyl aromatic polymers, in particular styrene polymers that do not show any of the existing restrictions.

For the particular case of vinyl aromatic polymer foams comprising petroleum coke as athermanous additive, WO 2014/102137 claims a combination of polyethylene wax and talc. The flame retardant illustrated is hexabromocyclodecane.

### Aims of the Invention

The present invention aims to provide expandable vinyl aromatic polymers that do not present the state of the art shortcomings; in other words to provide expandable vinyl aromatic polymers enabling the production of expanded beads allowing molded parts such as insulation panels showing an unique combination of thermal insulation properties, fire resistance and/or compressive properties for a low foam density, said molded parts being obtained in a safe economic and environmental attractive way.

### DRAWING

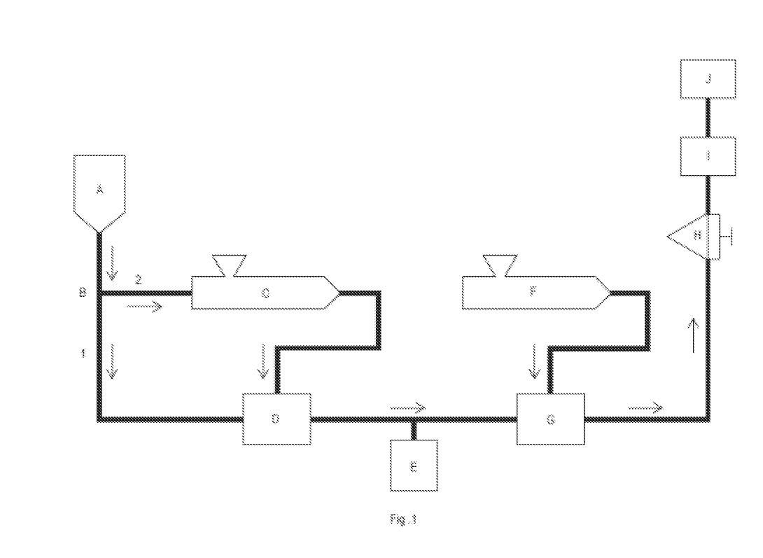

FIG. 1 represents a flow-sheet for the production of expandable vinyl aromatic polymer wherein:
(A) is the polymerization reactor producing a polymer stream;
(B) is the branching point where part of the polymer stream is derived creating a polymer side stream (2) and a main polymer stream (1);
(C) is the mixing unit, preferably an extruder, where comminuted coke particles and polyethylene wax are dispersed in the derived polymer side stream (2);
(D) is the merging point where both polymer streams (1, 2) join through a static mixer forming a new polymer stream;
(E) is the unit for the addition of blowing agent, preferably n-pentane and/or isopentane, to the new polymer stream;
(F) is the extruder where flame retardant agent and synergist are blended, optionally with vinyl aromatic polymer, before being fed into the new polymer stream through (G) to form the expandable vinyl aromatic polymer melt;
(H) is the under-water pelletizing unit;
(I) is the drying unit;
(J) is the packaging unit.

### SUMMARY OF THE INVENTION

The present invention discloses expandable vinyl aromatic polymers comprising:
from 1 to 10, preferably from 2 to 8% by weight of dispersed coke particles having a volume median particle diameter (D50) comprised between 0.5 and 8.5 μm, preferably between 1.0 and 7.5 μm, more preferably between 1.0 and 6.5 μm, as obtained from laser light scattering measurements according to ISO 13320 using MEK as solvent for vinyl aromatic polymers;
from 2 to 10% by weight, preferably from 3 to 7% by weight of a C3-C6 alkane, preferably a C4-C5 alkane blowing agent;
from 0.1 to 5.0, preferably from 0.2 to 2.5% by weight of a halogenated block copolymer, characterized by a weight average molecular weight comprised between 20 and 300 kDa, preferably between 30 and 200 kDa, as determined by gel permeation chromatography against polystyrene standards and comprising:
   from 20 to 60% by weight, preferably from 30 to 50% by weight of sequences (A) of polymerized monovinyl arenes and from 40 to 80% by weight, preferably from 50 to 70% by weight of sequences (B) of polymerized conjugated alkadienes or copolymerized conjugated alkadienes and monovinyl arenes; and
   from 20 to 80% by weight, preferably from 40 to 70% by weight of halogen substituents, preferably bromine.

Preferred embodiments of the present invention disclose one or more of the following features:
the expandable vinyl aromatic polymers additionally comprise from 0.01 to 1.0% by weight, preferably from 0.05 to 0.5% by weight of high density polyethylene as cell regulator;
the polyethylene is characterized by a weight average molecular weight (Mw) comprised between 1.5 and 10 kDa, preferably between 1.7 and 8 kDa, more preferably between 1.9 and 6 kDa and with a polydispersity of 3 or less, preferably of 2 or less, more preferably of 1.5 or less, and most preferably of 1.2 or less, as determined by gel permeation chromatography (GPC) in tetrahydrofuran using polystyrene standards;
the polyethylene is characterized by a homogeneous crystallization temperature (T_{C}) comprised between 50 and 100° C., preferably between 55 and 95° C., as determined by DSC, according to ASTM D3418 with a crystallization enthalpy (ΔHc) (reported to 100% wax) above 30 J/g;
the halogenated block copolymer is a brominated styrene-butadiene block copolymer characterized by a 5% by weight loss at a temperature of 250° C. or higher, preferably at a temperature of 260° C. or higher, as obtained from thermogravimetric analysis according to ISO11358;
the brominated styrene-butadiene block copolymer is a triblock copolymer including a central polybutadiene block with terminal blocks of the polymerized vinyl aromatic monomer wherein least 60% of the butadiene units is brominated;
the expandable vinyl aromatic polymers comprise between 0.1 and 3% by weight, preferably between 0.1 and 1.0% by weight of flame retardant synergist, preferably a thermal free radical generator of the type comprising a C—C or C—O—O—C thermo-labile bond.

The present invention further discloses a method for the preparation of beads or granules of the expandable vinyl aromatic polymer, comprising the steps of:
a. producing a polymer melt stream after the polymerization process of the vinyl aromatic polymer;
b. deriving a part of said polymer stream and creating main polymer melt stream (1) and a side loop with an additional polymer melt stream (2);
c. incorporating the coke particles and polyethylene foam cell regulator into said additional polymer melt stream (2);
d. joining the additional polymer stream (2) and the main stream (1) and forming a new polymer melt stream;
e. introducing a blowing agent into the new polymer melt stream;
f. cooling the vinyl aromatic polymer melt comprising all necessary ingredients to a temperature of 200° C. or less;
g. introducing brominated styrene-butadiene block copolymer and flame retardant synergist into the new polymer melt stream;
h. discharging through a die plate with holes, the diameter of which at the exit from the die is comprised between 0.3 and 1.5 mm, preferably between 0.5 and 1.0 mm and pelletizing the melt under water with a pressure above 3 bar, preferably above 5 bar.

Preferred embodiments of the process for the preparation of beads or granules of the expandable vinyl aromatic polymer disclose one or more of the following features:
between 5 and 30% of the polymer stream is derived in step b) to form the additional polymer stream (2);
in step c), the coke particles and the foam cell regulator are dispersed in the additional polymer stream (2) by means of an extruder;
the dispersion in step c) is performed in the polymer melt at a temperature comprised between 180 and 250° C., more preferably between 200 and 240° C., most preferably between 210 and 230° C.;
in step g) one or more thermal stabilizer(s) and anti-acid(s) are added.

The present invention additionally discloses polymer foams obtained from the molding of the expanded vinyl aromatic polymers, said foams being characterized by:
a thermal conductivity, in accordance to DIN 52612, of less than 33 mW/m·K for a foam density of less than 13 kg/m³;
a fire retardancy with B2 rating, in accordance to DIN 4102-1 with an average flame height of less than 10 cm;
   or by:
a thermal conductivity, in accordance to DIN 52612, of less than 33 mW/m·K for a foam density of less than 13 kg/m³;
a compressive strength at 10% deformation (σ10), in accordance to ISO 844-EN 826, of at least 60 kPa for a foam density of less than 13 kg/m³. or by:
a thermal conductivity, in accordance to DIN 52612, of less than 33 mW/m·K for a foam density of less than 13 kg/m³;
a compressive strength at 10% deformation (σ10), in accordance to ISO 844-EN 826, of at least 100 kPa for a foam density of less than 20 kg/m³.

### DETAILED DESCRIPTION OF THE INVENTION

It is an object of the present invention to provide expandable vinyl aromatic polymers, in particular styrene polymers containing homogeneously dispersed coke particles which can be processed to expanded foams which have a low density and a low thermal conductivity, good physical properties, in particular compressive strength, and good flame retardant properties.

We have found that this object is achieved by expandable vinyl aromatic polymers, in particular styrene polymers, comprising a particular combination of homogeneously dispersed coke particles, polyethylene wax and a halogenated block copolymer.

Expandable vinyl aromatic polymers, in particular styrene polymers, are vinyl aromatic polymers comprising blowing agent, preferably n-pentane and/or isopentane. The size of the expandable polymer beads is preferably in the range from 0.2 to 2 mm, preferably from 1 to 1.5 mm. Molded polymer foams can be obtained via prefoaming and sintering of the appropriate expandable vinyl aromatic polymer beads, in particular of the styrene polymer beads.

The vinyl aromatic polymers preferably used in the present invention comprise general purpose or glass-clear polystyrene (GPPS), high impact polystyrene (HIPS), anionically polymerized polystyrene, styrene-alpha-methylstyrene copolymers, acrylonitrile-butadiene-styrene polymers (ABS), styrene-acrylonitrile polymers (SAN), acrylonitrile-styrene-acrylate (ASA), styrene acrylates, such as styrene-methyl acrylate and styrene-methyl methacrylate (SMMA), styrene maleic anhydride (SMA), methyl methacrylate-butadiene-styrene (MBS), methyl methacrylate-acrylonitrile-butadiene-styrene (MABS) polymers, styrene-N-phenylmaleimide copolymers (SPMI) or a mixture thereof.

The weight average molecular weight of the expandable vinyl aromatic polymers, in particular styrene polymers, of the present invention is preferably in the range from 100 kDa to 400 kDa, particularly preferably in the range from 150 kDa to 300 kDa, measured by means of gel permeation chromatography against polystyrene standards. The molar mass of the expandable vinyl aromatic polymers, after the extrusion processes is generally below the molar mass of the vinyl aromatic polymers, before the extrusion process, because of the degradation caused by shear and/or by heat. The molar mass difference due to extrusion can be up to 10 kDa.

The above-mentioned vinyl aromatic polymers, can be blended with thermoplastic polymers, such as polyamides (PA), polyolefins, e.g. polypropylene (PP) or polyethylene (PE), polyacrylates, e.g. polymethyl methacrylate (PMMA), polycarbonate (PC), polyesters, e.g. polyethylene terephthalate (PET) or polybutylene terephthalate (PBT), polyphenylene ethers (PPE), polyether sulfones (PES), polyether ketones, or polyether sulfides (PES), or a mixture thereof, generally in total proportions of up to at most 30% by weight, preferably in the range from 1 to 10% by weight, based on the polymer melt, in order to improve mechanical properties or heat resistance, optionally with use of compatibilizers. Mixtures within the abovementioned ranges of amounts are also possible with, for example, hydrophobically modified or functionalized polymers or oligomers, rubbers, e.g. polyacrylates or polydienes, for example styrene-butadiene block copolymers, or biodegradable aliphatic or aliphatic/aromatic copolyesters.

The coke to be used with the expandable vinyl aromatic polymers of the present invention is obtained from grinding coke, preferably petroleum coke. The petroleum coke used in the present invention is a residue of petroleum distillation and is produced in so-called crackers. The petroleum coke is liberated from the volatile components through calcination, as a result of which a carbon with a degree of purity of about 99% is obtained. Therefore, coke may be regarded as a carbon, but is not included in the allotropic forms. Calcined petroleum coke is neither graphite nor can it be included in the amorphous carbons, like carbon black.

Grinding is preferably performed in a delamination mill, such as for example an air jet mill and preferably a spiral flow mill, in such a way that a particle size distribution (before incorporation in the expandable vinyl aromatic polymer), as determined by the laser light scattering granulometry technique and calculated using the Fraunhofer/Mie model, with a volume median particle diameter (D50) comprised between 0.5 and 15 μm, preferably between 1 and 10 μm, more preferably between 1 and 8 μm is obtained.

The technique of laser diffraction is based on the principle that particles passing through a laser beam will scatter light at an angle that is directly related to their size: large particles scatter at low angles, whereas small particles scatter at high angles. The laser diffraction is accurately described by the Fraunhofer approximation and the Mie theory, with the assumption of spherical particle morphology.

Concentrated suspensions, comprising about 1.0% by weight of carbon based particles, are prepared, using suitable wetting and/or dispersing agents.

Suitable solvents are for example water or organic solvents such as for example ethanol, isopropanol, octane or methyl ethyl ketone. A sample presentation system ensures that the material under test passes through the laser beam as a homogeneous stream of particles in a known, reproducible state of dispersion.

In the present invention the particle size distribution has been measured by laser light scattering using the particle size analyzer (HORIBA 920) from (Horiba Scientific) according to ISO 13320. The samples of expandable vinyl aromatic polymers with coke as filler are dissolved in methyl ethyl ketone at a concentration of about 1% weight, without the use of ultrasonication. This technique is used to characterize rubber particle size distribution in high impact polystyrene (HIPS) since more than 30 years (R. A. Hall, R. D. Hites, and P. Plantz, “Characterization of rubber particle size distribution of high-impact polystyrene using low-angle laser light scattering”, J. Appl. Polym. Sci. 27, 2885, (1982)).

Particle size measurements are performed on pure solvent, e.g. 150 ml of methyl ethyl ketone, to which either the concentrated suspension of carbon based particles or the solution of expandable vinyl aromatic polymer comprising carbon based particles is added drop by drop until the concentration of carbon based particles is such that a transmission, as displayed by the particle size analyzer (HORIBA 920), comprised between 75 and 90% is obtained.

The coke comprised in the vinyl aromatic polymer foam of the present invention is characterized by a monomodal or polymodal particle size distribution.

The coke comprised in the vinyl aromatic polymer foam of the present invention is characterized by a volume median particle diameter (D50) comprised between 0.5 and 8.5 μm, preferably between 1.0 and 7.5 μm, more preferably between 1.0 and 6.5 μm and by a volume percentage of particles with a diameter of less than 1 μm of less than 50, preferably less than 45, as obtained from laser light scattering measurements according to ISO 13320. It should be noted that there is always a comminution of coke particles during processing, so the D50 of the coke before processing is typically 10 to 20% higher than D50 of the coke inside the expandable vinyl aromatic polymer.

The expandable vinyl aromatic polymer comprises from 1 to 10% by weight, preferably from 2 to 8% by weight of homogeneously dispersed coke particles.

By homogeneously dispersed the present invention means that particles with an equivalent diameter of more than 40 μm are observed by less than 1%, preferably by less than 0.5%, more preferably by less than 0.1% in a method analogous to those described in ISO 18553.

The homogeneity of the dispersion of the athermanous particle is quantified on a compression-moulded film with a thickness comprised between 10 and 30 μm, preferably of about 20 μm. The film is obtained after melting a few EPS beads at 200° C. to allow release of blowing agent, applying pressure for 15 minutes and cooling to 35° C. under pressure. The film is examined in transmission with an optical microscope (Nikon LV100) using a 20× lens. The dispersed black particles are counted and measured (area and perimeter) with image analyser NIS Element AR. The percentage of area covered by particles with equivalent diameter above 40 μm is calculated on the basis of 10 different image fields (10×290000 μm² or 2.9 mm²). The criterion for inhomogeneous dispersion is that the percentage area of particles above 40 μm equivalent diameter be above 1%.

D_{eq}=(4A/π)^{0.5}, wherein A is the projected area of the particle.

Polyethylene used in the expandable vinyl aromatic polymers of the present invention preferably is high density polyethylene with a melting temperature above 90° C., as determined by Differential Scanning Calorimetry (DSC), at a heating rate of 10° C./min., according to ASTM D3418.

The polyethylene, when incorporated in the vinyl aromatic polymer foam, is characterized by:
a crystallization temperature comprised between 50 and 100° C., preferably between 55 and 95° C., as determined by DSC, with a crystallization enthalpy, reported to 100% polyethylene wax, of more than 30 J/g. This crystallization can be ascribed to polyethylene wax in sub-microscopic nodules. Crystallization in those nodules occurs by homogeneous nucleation.
a weight average molecular weight (Mw) comprised between 1.5 to 10 kDa, preferably between 1.7 to 8 kDa, more preferably 1.9 and 6 kDa, with a polydispersity of 3 or less, preferably of 2 or less, more preferably of 1.5 or less, most preferably of 1.2 or less, as determined by gel permeation chromatography (GPC) in tetrahydrofuran using polystyrene standards.

The crystallization temperature and crystallization enthalpy are determined by Differential Scanning Calorimetry (DSC) on a DSC1 apparatus from Mettler Toledo with an intra-cooler TC100 (Huber). All DSC experiments are performed under a nitrogen flow rate of 80 ml/min. Temperature and enthalpy calibrations are realized with high purity indium following Mettler's instructions with guidelines described in ASTM D3418 (practices E967 and E968 for temperature and heat flow calibrations, respectively).

The samples are placed in 40 μl aluminium cups. A typical weight around 12 mg (precision to 0.01 mg) is selected for EPS samples comprising 0.05 to 0.6% waxes. Prior to DSC analyses, a 1 mm thick sheet is produced from EPS beads containing blowing agent, wherein a heating stage of 5 minutes at 200° C., without pressure, followed by a compression stage of 10 minutes at 200° C. and cooling stage under pressure to 35° C. ensures a blowing agent-free sample, as confirmed by the absence of weight loss during the DSC experiment.

The temperature profile applied consists of:
25° C. isotherm 2 min,
25° C. to 200° C. heating ramp with 10° C./min,
isotherm 200° C. 3 min,
rapid cooling to 25° C. at 50° C./min,
heating ramp 10° C./min to 180° C.,
isotherm of 2 min at 180° C.,
cooling at 10° C./min to 25° C.

In addition to homogeneous crystallization, a second crystallization, the so-called heterogeneous crystallization, may be observed at higher temperature, with peak crystallization temperature typically below 125° C. and above 85° C. Heterogeneous crystallization in general is found for larger wax nodules in vinyl aromatic polymer blends comprising minor amounts of polyethylene wax. The peak crystallization temperature related to heterogeneous crystallization of polyethylene wax inside expandable polystyrene (EPS) appears at temperature close to that observed for crystallization of the same pure polyethylene wax. For small quantities of polyethylene wax present in the EPS, the heterogeneous crystallization peak, expected in the temperature range from 90° C. to 110° C., is masked by the glass transition of polystyrene.

The expandable vinyl aromatic polymer comprises from 0.01 to 1.0% by weight, preferably from 0.05 to 0.5% by weight, more preferably from 0.08 to 0.35% by weight of polyethylene.

The polyethylene wax may be used in combination with one or more inorganic cell regulators selected from the group consisting of talc; titanium dioxide; clays such as kaolin; silicagel; calcium polysilicate; gypsum; metal particles; calcium carbonate; calcium sulfate; magnesium carbonate; magnesium hydroxide; magnesium sulfate; barium sulfate; diatomaceous earth; nano-particles such as nano-particles of calcium carbonate, nano clay and nano-graphite. However, it is observed that the adjunction of mineral nucleating agent does not significantly influence the nucleating ability of polyethylene wax (negligible influence on average cell size and hence thermal conductivity) when included in a polystyrene matrix with coke as athermanous filler. This observation is different from the one reported previously (WO 2012/175345) for expanded polystyrene foams with carbon black as athermanous filler where both nucleating agents are necessary for a good cellular morphology and enhanced thermal insulation performances.

The expandable vinyl aromatic polymer may comprise up to 3% by weight preferably up to 2% by weight, more preferably up to 0.9% by weight, most preferably up to 0.5% by weight or even up to 0.24% by weight of inorganic cell regulator. Preferably talc is used as inorganic cell regulator.

Preferably, the expandable vinyl aromatic polymer comprises polyethylene without inorganic cell regulator.

The flame-retardant agents to be used in the expandable vinyl aromatic compositions of the present invention are chlorinated and/or brominated polymers more particularly chlorinated and brominated block copolymers obtained from the halogenation of block copolymers comprising from 20 to 60% by weight, preferably from 30 to 50% by weight of sequences (A) of polymerized monovinyl arenes and from 40 to 80% by weight, preferably from 50 to 70% by weight of sequences (B) of polymerized conjugated alkadienes or copolymerized conjugated alkadienes and monovinyl arenes.

The mono vinyl arene units preferably are styrene units formed by polymerizing styrene. However, other mono vinyl arene units can be present, such as α-methyl styrene, 2-, 3- or 4-methyl styrene, other alkyl-substituted styrenes such as ethyl styrene. Mixtures of two or more different types of mono vinyl arene units can be present.

The block copolymers further are characterized by a weight average molecular weight (Mw) comprised between 20 kDa and 300 kDa, preferably between 30 kDa and 200 kDa as determined by gel permeation chromatography in tetrahydrofuran against polystyrene standards.

The halogenated block copolymer may be a diblock copolymer or triblock copolymer. A triblock copolymer preferably includes a central block of sequence (B) with terminal blocks of sequence (A).

Brominated block copolymers containing at least 35% by weight bromine are preferred.

At least 90% of the bromine is bonded to the monomer units of sequence (B); as much as 100% of the bromine may be bonded the monomer units of sequence (B).

At least 60% of the monomer units of sequence (B) of the starting polymer may be brominated,

Preferably, the halogenated block copolymer is a brominated styrene-butadiene block copolymer.

The brominated styrene-butadiene block copolymer preferably is a diblock copolymer, more preferably triblock copolymer including a central polybutadiene block with terminal blocks of the polymerized styrene monomer.

Brominated styrene-butadiene block copolymers containing at least 35% by weight bromine are preferred.

At least 90% of the bromine is bonded to the butadiene units; as much as 100% of the bromine may be bonded the butadiene units. Bromination produces brominated 1,2-butadiene and 1,4-butadiene units.

At least 60% of the butadiene units of the starting polymer may be brominated.

The weight loss from the halogenated polymer in thermo-gravimetric analysis (TGA) according to ISO 11358, is 5% by weight at a temperature of 250° C. or higher, preferably in the range from 260° C. or higher.

The expandable vinyl aromatic polymers of the present invention comprise between 0.1 and 5% by weight, preferably in the range between 0.2 and 2.5% by weight, based on the vinyl aromatic polymer, of the halogenated polymers, preferably brominated block copolymers, wherein the brominated styrene-butadiene block copolymers are homogeneously dispersed, forming a dispersed phase in the continuous phase of vinyl aromatic polymer.

Homogeneity of the dispersion of the brominated styrene-butadiene block copolymer is assessed using electron microscopy (with bright brominated block copolymers nodules revealed by electron dispersive X-Ray detector) of a section through the expandable vinyl aromatic polymer bead.

The effectiveness of the halogenated block copolymer, in particular the brominated styrene-butadiene, can be still further improved via addition of suitable flame retardant synergists, examples being the thermal free-radical generators dicumyl, dicumyl peroxide, cumyl hydroperoxide, di-tert-butyl peroxide, tert-butyl hydroperoxide, or a mixture thereof. Another example of suitable flame retardant synergist is antimony trioxide.

Flame retardant synergists are generally used in amounts of from 0.05 to 5% by weight, based on the polymer foam, in addition to the halogenated polymer.

Expandable vinyl aromatic polymers are vinyl aromatic polymers comprising blowing agent. The vinyl aromatic polymer generally comprises from 2% to 10% by weight, preferably from 3% to 7% by weight, of one or more blowing agents distributed homogeneously. Suitable blowing agents are the physical blowing agents usually used in expandable styrene polymers e.g. aliphatic hydrocarbons having from 2 to 7 carbon atoms, alcohols, ketones, ethers, or halogenated hydrocarbons. Preferred blowing agents are isobutane, n-butane, isopentane, or n-pentane, preferably blends of isopentane and n-pentane. On the other hand sustainable blowing agents such as water or supercritical carbon dioxide may be used.

The expandable vinyl aromatic polymers further can comprise the usual and known auxiliaries and additives, examples being, fillers, UV stabilizers, chain-transfer agents, plasticizers, antioxidants, soluble and insoluble inorganic and/or organic dyes and pigments.

The expandable vinyl aromatic polymers of the present invention comprise:
between 1 and 10% by weight, preferably between 2 and 8% by weight of coke particles;
between 0.01 and 1.0% by weight, more preferably between 0.05 and 0.5% by weight of polyethylene;
between 0.1 and 5.0% by weight, preferably between 0.2 and 2.5% by weight of brominated styrene-butadiene-styrene copolymer;
between 0.1 and 3% by weight, preferably between 0.1 and 1.0% by weight of flame retardant synergist, preferably a thermal free radical generator of the type comprising a C—C or a C—O—O—C thermos-labile bond; and
between 2 and 10% by weight, preferably between 3 and 7% by weight of a C3-C6 alkane, preferably a C4-C5 alkane blowing agent.

It is advantageous that the molded foams have a density of less than 18 kg/m³, preferably less than 16 kg/m³.

It has been demonstrated that vinyl aromatic polymer foams obtained from the expandable vinyl aromatic polymers comprising the particular combination of components of the present invention allow for a thermal conductivity, in accordance to ISO 8301, of less than 33 mW/m·K for a foam density of less than 13 kg/m³, a fire retardancy with B2 rating, in accordance to DIN 4102-1, with an average flame height of less than 10 cm, and/or a compressive strength, in accordance with ISO 844-EN 826, of at least 60, 75 and 100 kPa for a foam density of 12.5 or less, 15 or less and 18 kg/m³ or less, respectively.

Thermal conductivity is determined according to ISO 8301 using a heat flow meter device, with a mean temperature of 10° C. and a temperature difference of 20° C.

Thermal conductivity, compressive strength and fire retardancy are measured on samples after being kept in an oven at 70° C. for 7 days.

Athermanous particles different from coke particles, such as for example carbon black, require higher amounts of polyethylene, and brominated styrene-butadiene block copolymers to achieve the comparable values for thermal insulation, flame retardancy and compressive strength. The inventors have found that expandable vinyl aromatic polymers comprising coke, polyethylene, and brominated styrene-butadiene block copolymer with the characteristics as claimed in the present invention, allow to obtain optimal foam properties in economical most favorable conditions.

Various processes can be used to produce the particularly preferred expandable vinyl aromatic polymers. After the polymerization process, the melt stream is divided into a main polymer stream (1) and an additional polymer side stream (2) (FIG. 11). The side stream (2) constitutes a loop to take up the first additive package, for example coke and polyethylene foam cell regulator, while blowing agent is added to the polymer stream after merging the main polymer stream (1) and the additional polymer stream (2) comprising the first additive package.

In a preferred embodiment, comminuted coke particles are taken as starting point together with polyethylene foam cell regulator. These components are simultaneously fed into the additional polymer side stream (2) of the vinyl aromatic polymer via a mixing unit, preferably via an extruder. After dispersion of the first additive package, said additional polymer stream (2) joins again the main polymer stream (1), both in the molten stage, preferably through a static mixer. Subsequently blowing agent is added.

The vinyl aromatic polymer melt comprising blowing agent, coke particles, polyethylene foam cell regulator and in a later stage flame retardant agent and synergist, after homogenization, is rapidly cooled under pressure, in order to avoid foaming. It is therefore advantageous to carry out underwater pelletizing in a closed system under pressure.

Particular preference is given to a process for producing flame-retarded, expandable vinyl aromatic polymers, comprising the steps of:
a. producing a polymer melt stream after the polymerization process of the vinyl aromatic polymer;
b. deriving a part of said polymer stream and creating main polymer melt stream (1) and a side loop with an additional polymer melt stream (2);
c. using an extruder for incorporating the comminuted coke particles and polyethylene foam cell regulator into said additional polymer melt stream (2), at a temperature of at least 160° C., preferably comprised between 180 and 250° C., more preferably between 200 and 240° C., most preferably between 210 and 230° C.;
d. joining the additional polymer stream (2) and the main stream (1) and forming a new polymer melt stream;
e. introducing a blowing agent into the new polymer melt stream;
f. cooling the vinyl aromatic polymer melt comprising all necessary ingredients to a temperature of 200° C. or less preferably a temperature comprised between 120° C. and 200° C.;
g. introducing brominated styrene-butadiene block copolymer and flame retardant synergist into the new polymer melt stream;
h. discharging through a die plate with holes, the diameter of which at the exit from the die is comprised between 0.3 and 1.5 mm, preferably between 0.5 and 1.0 mm;
i. pelletizing the melt directly downstream of the die plate under water at a pressure above 3 bar, preferably above 5 bar.

The pellets (beads, granules) can then further be coated and processed to give expanded vinyl aromatic polymer foams, in particular polystyrene foams.

In a first step, the expandable vinyl aromatic polymer pellets of the invention can be prefoamed by using hot air or steam, in what are known as prefoamers, to give foam beads of density in the range from 8 to 200 kg/m³, in particular from 10 to 50 kg/m³ preferably from 10 to 20 kg/m³. Eventually, in order to reach the lower densities a second prefoaming step can be applied. After maturation, in a next step the prefoamed beads (to which a coating has been applied) are placed in molds where they are treated with steam and where they are further expanded and fused to give molded foams.

### Examples

The examples in Table 1 illustrate the invention; they are merely meant to exemplify the present invention but are not destined to limit or otherwise define the scope of the present invention. Examples 1 to 10 are according to the present invention; Examples 11 to 15 are comparative.

Examples 1 to 12 comprise 5.5% by weight of coke; Examples 13 to 15 comprise 5.5% by weight of carbon black. All examples comprise various amounts of polyethylene wax, except Example 10 comprising only talc, at 2% by weight, as cell regulator. All examples comprise 1.2% by weight of brominated styrene butadiene block copolymer—Emerald Innovation™ 3000 (Chemtura) and 0.33% by weight, of 2,3-dimethyl-2,3-diphenylbutane (synergist) except Example 10, comprising 4% by weight of Emerald Innovation™3000 (Chemtura) and 0.93% by weight of 2,3-dimethyl-2,3-diphenylbutane (synergist); and Example 15 comprising 2.5% by weight of Emerald Innovation™3000 (Chemtura) and 0.63% by weight of 2,3-dimethyl-2,3-diphenylbutane (synergist);

wherein:
Examples 11 and 12 illustrate coke particles with a D50 higher than 8.5 μm;
Examples 13 to 15 illustrate athermanous particles different from coke (carbon black).

In Table 1,
column 1 indicates the identification number of the example and the comparative example (C);
column 2 indicates the volume medium particle diameter (D50), in μm, of the athermanous particle, wherein (AC) stands for anode coke; (NC) stands for needle coke and (CB) stands for carbon black, as determined by laser diffraction spectroscopy of athermanous particle obtained from dispersing expandable vinyl aromatic polymer in methyl ethyl ketone.
column 3 indicates the weight percentage of polyethylene wax and the weight percentage of talc, where present, wherein PW stands for Polywax (Baker Hughes), CE stands for Ceralene (EuroCeras), and ACC stands for Acculin (The International Group Inc.);
column 4 indicates the weight percentage of brominated styrene butadiene block copolymer—Emerald InnovationTM3000 flame retardant;
column 5 indicates the average flame height, in cm, according to DIN 4102;
column 6 indicates the crystallization temperature of the homogeneous crystallization peak as measured by DSC at a cooling rate of 10° C./min. according to ASTM D3418;
column 7 indicates the crystallization enthalpy (J/g) of the polyethylene wax homogeneous crystallization peak in the vinyl aromatic copolymer foam, reported to 100% wax, as measured by DSC at a cooling rate of 10° C./min. according to ASTM D3418;
columns 8, 9 and 10 indicate the thermal conductivity (λ) in mW/m·K for a foam density (ρ) of respectively 12.5, 15 and 18 g/I for a foam comprising 5.5% by weight of athermanous particles;
columns 11, 12 and 13 indicate the compressive strength in kPa at 10% deformation (σ10) for a foam density (φ of respectively 12.5, 15 and 18 g/l for a foam comprising 5.5% by weight of athermanous particles.

The foam panels derived from the expandable vinyl aromatic polymers according to the present invention all have B2 rating (DIN 4102) and the average flame height below 10 cm.

The thermal conductivity (λ, in mW/m·K), is determined in accordance to ISO 8301 and the compressive strength (kPa), is determined in accordance to ISO 844-EN 826 (crosshead speed 8 mm/min, foam bloc with dimension (mm) 80×80×80). Measurements are performed after the foam blocks have been stored for 7 days at a temperature of 70° C., conditions ensuring a residual blowing agent concentration of 0.4% by weight or lower.

As appears from Table 1, all examples according to the invention answer the combined criteria of:
a thermal conductivity, in accordance to ISO 8301, of less than 33 mW/m·K for a foam density of less than 13 kg/m³;
a fire retardancy with B2 rating, in accordance to DIN 4102-1 with an average flame height of less than 10 cm; and
a compressive strength at 10% deformation (σ10), in accordance to ISO 844-EN826, of at least 60 kPa or more for a foam density of less than 13 kg/m³.

For all examples and comparative examples, athermanous particles with an equivalent diameter of more than 40 μm were observed by less than 0.1% (according to a method analogous to those described in ISO 18553).

TABLE 1

| | | | | | | | | Thermal Conductivity | | | Compressive Strength | | |
|---|---|---|---|---|---|---|---|---|---|---|---|---|---|
| | | | | | | | | (λ) a.f.o. | | | (σ10) a.f.o. | | |
| | | | | | | | | foam density for | | | foam density for | | |
| | | | | | | | | 85.5 wt % of coke | | | 5.5 wt % of coke | | |
| 1 | 2 | | 3 | 4 | 5 | 6 | 7 | 8 | 9 | 10 | 11 | 12 | 13 |
| Ex. | D50 | | PE | FR | FH | Tc | ΔHc | ρ (12.5) | ρ (15) | ρ (18) | ρ (12.5) | ρ (15) | ρ (18) |
| 1 | 7.8 | (NC) | 0.13 (PW 2000) | 1.2 | 8 | 74 | 84 | 32.5 | 31.5 | 30.8 | 60 | 78 | 103 |
| 2 | 7.9 | (NC) | 0.11 (ACC 2000) | 1.2 | 7 | 74 | 70 | 32.5 | 31.7 | 31.0 | 62 | 81 | 106 |
| 3 | 6.1 | (AC) | 0.15 (PW 2000) | 1.2 | 8 | 74 | 85 | 32.8 | 31.6 | 30.7 | 63 | 82 | 104 |
| 4 | 6.1 | (AC) | 0.30 (ACC 2000) | 1.2 | 8 | 75 | 105 | 32.8 | 31.7 | 30.8 | 61 | 80 | 103 |
| 5 | 6.1 | (AC) | 0.40 (CE 1M) | 1.2 | 7 | 60 | 103 | 32.8 | 31.6 | 30.8 | 61 | 80 | 104 |
| 6 | 1.2 | (AC) | 0.18 (PW 2000) | 1.2 | 8 | 74 | 100 | 32.2 | 31.2 | 30.4 | 62 | 80 | 105 |
| 7 | 4.1 | (NC) | 0.20 (PW 2000) | 1.2 | 7 | 74 | 108 | 31.1 | 30.3 | 29.8 | 61 | 80 | 103 |
| 8 | 4.1 | (NC) | 0.14 (PW2000) | 1.2 | 8 | 74 | 83 | 31.4 | 30.6 | 30.0 | 60 | 80 | 104 |
| 9 | 4.1 | (NC) | 0.14/0.2 (PW 2000/Talc) | 1.2 | 8 | 74 | 85 | 31.2 | 30.5 | 29.9 | 60 | 79 | 105 |
| 10 | 6.1 | (AC) | 2.0 (Talc) | 4 | 9 | NA | NA | 32.9 | 32.5 | 31.5 | 61 | 78 | 105 |
| 11 | 11.5 | (NC) | 0.12 (PW 2000) | 1.2 | 7 | 74 | 40 | 34.2 | 33.1 | 32.1 | 54 | 67 | 86 |
| 12 | 9.0 | (AC) | 0.14 (PW 2000) | 1.2 | 8 | 74 | 80 | 34.6 | 32.9 | 32.0 | 59 | 78 | 103 |
| 13 | 0.6 | (CB1) | 0.2/1.0 (PW 2000/Talc) | 1.2 | >15 | 74 | 38 | 33.1 | 31.7 | 30.8 | 62 | 81 | 105 |
| 14 | 0.5 | (CB2) | 0.2/2.0 (PW 2000/Talc) | 1.2 | >15 | 74 | 25 | 31.5 | 30.9 | 30.2 | 58 | 76 | 99 |
| 15 | 0.5 | (CB1) | 0.2/2.0 (PW 2000/Talc) | 2.5 | >15 | 74 | 25 | 31.6 | 30.9 | 30.2 | 58 | 76 | 99 |

### NA: Not Applicable

### CB1: Timcal Ensaco 150G

### CB2: Cabot CSX691

1.-15. (canceled)

16. An expandable vinyl aromatic polymer comprising:
from 1% to 10% by weight of dispersed coke particles having a volume median particle diameter (D50) comprised between 0.5 and 8.5 μm as obtained from laser light scattering measurements according to ISO 13320 using MEK as solvent for vinyl aromatic polymers;
from 2 to 10% by weight of a C3-C6 alkane;
from 0.1 to 5.0 by weight of a halogenated block copolymer, characterized by a weight average molecular weight comprised between 20 and 300 kDa as determined by gel permeation chromatography against polystyrene standards and comprising:
from 20 to 60% by weight of sequences (A) of polymerized monovinyl arenes and from 40 to 80% by weight of sequences (B) of polymerized conjugated alkadienes or copolymerized conjugated alkadienes and monovinyl arenes; and
from 20 to 80% by weight of halogen substituents.

17. The expandable vinyl aromatic polymer according to claim 16 additionally comprising from 0.01 to 1.0% by weight of high density polyethylene as cell regulator.

18. The expandable vinyl aromatic polymer according to claim 17 wherein the polyethylene is characterized by a weight average molecular weight (Mw) comprised between 1.5 and 10 kDa and with a polydispersity of 3 or less as determined by gel permeation chromatography (GPC) in tetrahydrofuran using polystyrene standards.

19. The expandable vinyl aromatic polymers according to claim 17 wherein the polyethylene is characterized by a homogeneous crystallization temperature (T_{C}) comprised between 50 and 100 C as determined by DSC, according to ASTM D3418 with a crystallization enthalpy (ΔHc) (reported to 100% wax) above 30 J/g.

20. The expandable vinyl aromatic polymers according to any of the preceding claims wherein the halogenated block copolymer is a brominated styrene-butadiene block copolymer characterized by a 5% by weight loss at a temperature of 250 C or higher as obtained from thermogravimetric analysis according to ISO11358.

21. The expandable vinyl aromatic polymers according to any of the preceding claims wherein the brominated styrene-butadiene block copolymer is a triblock copolymer including a central polybutadiene block with terminal blocks of the polymerized vinyl aromatic monomer wherein least 60% of the butadiene units is brominated.

22. The expandable vinyl aromatic polymers according to claim 16 comprising between 0.1 and 3% by weight of flame retardant synergist.

23. The expandable vinyl aromatic polymers according to claim 22 wherein the flame retardant synergist comprises a thermal free radical generator of the type comprising a C—C or C—O—O—C thermo-labile bond.

24. A process for the preparation of beads or granules of an expandable vinyl aromatic polymer according to any of the preceding claims comprising the steps of:
a) producing a polymer melt stream of an expandable vinyl aromatic polymer, said expandable vinyl aromatic polymer comprising
from 1% to 10% by weight of dispersed coke particles having a volume median particle diameter (D50) comprised between 0.5 and 8.5 μm as obtained from laser light scattering measurements according to ISO 13320 using MEK as solvent for vinyl aromatic polymers;
from 2 to 10% by weight of a C3-C6 alkane;
from 0.1 to 5.0 by weight of a halogenated block copolymer, characterized by a weight average molecular weight comprised between 20 and 300 kDa as determined by gel permeation chromatography against polystyrene standards and comprising:
from 20 to 60% by weight of sequences (λ) of polymerized monovinyl arenes and from 40 to 80% by weight of sequences (B) of polymerized conjugated alkadienes or copolymerized conjugated alkadienes and monovinyl arenes; and
from 20 to 80% by weight of halogen substituents.
b) deriving a part of said polymer stream and creating main polymer melt stream (1) and a side loop with an additional polymer melt stream (2);
c) dispersing the coke particles and polyethylene foam cell regulator into said additional polymer melt stream (2);
d) joining the additional polymer stream (2) and the main stream (1) and forming a new polymer melt stream;
e) introducing a blowing agent into the new polymer melt stream;
f) cooling the polymer melt comprising all ingredients to a temperature of 200° C. or less;
g) introducing brominated styrene-butadiene block copolymer and flame retardant synergist into the new polymer melt stream;
h) discharging the melt stream through a die plate with holes and pelletizing the melt under water with a pressure above 3 bar.

25. The process according to claim 24 wherein between 5 and 30% of the polymer stream is derived in step b) to form the additional polymer stream (2).

26. The process according to claim 24 wherein, in step c), the coke particles and the foam cell regulator are dispersed in the additional polymer stream (2) by means of an extruder.

27. The process according to claim 24 wherein the dispersion in step c) is performed in the polymer melt at a temperature comprised between 180 and 250 C.

28. The process according to claim 24 wherein in step g) one or more thermal stabilizer(s) and anti-acid(s) are added.

29. Polymer foams obtained from the molding of expanded vinyl aromatic polymers according to claim 16, said foams being characterized by:
a thermal conductivity, in accordance to DIN 52612, of less than 33 mW/m·K for a foam density of less than 13 kg/m³;
a fire retardancy with B2 rating, in accordance to DIN 4102-1.

30. Polymer foams obtained from the molding of expanded vinyl aromatic polymers according to claim 16, said foams being characterized by:
a thermal conductivity, in accordance to DIN 52612, of less than 33 mW/m·K for a foam density of less than 13 kg/m³;
a compressive strength at 10% deformation (610), in accordance to ISO 844-EN 826, of at least 60 kPa for a foam density of less than 13 kg/m³.

31. Polymer foams obtained from the molding of expanded vinyl aromatic polymers according to claim 16, said foams being characterized by:
a thermal conductivity, in accordance to DIN 52612, of less than 33 mW/m·K for a foam density of less than 13 kg/m³;
a compressive strength at 10% deformation (10), in accordance to ISO 844-EN 826, of at least 100 kPa for a foam density of less than 20 kg/m³.
